(19) United States
(12) Patent Application Publication
(10) Pub. No.: US 2015/0004271 A1
(43) Pub. Date: Jan. 1, 2015

(54) Mold-Tool System Including Stem-Actuator Assembly Configured to Exert Controlled Movement of Valve-Stem Assembly

(71) Applicant: Husky Injection Molding Systems Ltd., Bolton (CA)

(72) Inventor: Edward Joseph Jenko, Essex, VT (US)

(21) Appl. No.: 14/372,756

(22) PCT Filed: Jan. 15, 2013
(86) PCT No.: PCT/US13/21522

§ 371 Date: Jul. 17, 2014

Related U.S. Application Data
(60) Provisional application No. 61/587,139, filed on Jan. 17, 2012.

(51) Int. Cl. B29C 45/77

(52) U.S. Cl. CPC B29C 45/77; B29C 2045/1787
USPC 425/149

(57) ABSTRACT

A mold-tool system (100), comprising: a valve-stem assembly (102) being configured to move in a nozzle assembly (104), the valve-stem assembly (102) being configured to interact with a mold-gate orifice (105) defined by a mold-gate assembly (106); and a stem-actuator assembly (108) being configured to exert controlled movement of the valve-stem assembly (102) based on an amount of force (109) interacting between the valve-stem assembly (102) and the mold-gate assembly (106).

### BACKGROUND

U.S. Pat. No. 6,135,757 discloses a valve gated injection molding system.

U.S. Pat. No. 6,228,309 discloses an apparatus for injection molding including valve stem positioning.

U.S. Pat. No. 7,037,103 discloses an apparatus for injection molded articles.

United States Patent Publication Number US 2006/0153945 discloses a valve stem having a reverse taper.

### SUMMARY

The inventor has researched a problem associated with known molding systems that inadvertently manufacture bad-quality molded articles or parts. After much study, the inventor believes he has arrived at an understanding of the problem and its solution, which are stated below:

For hot runner valve gate shut-off there are generally two types of configuration. The first type, sometimes referred to as a plunger, includes a valve stem having a cylindrical front portion which moves into a cylindrical cavity orifice (gate hole) with a very small clearance between the two cylindrical features. This very small clearance essentially stops the flow of plastic (flowable resin), while a valve stem cools and forms a small portion of the molding surface. The problem exists that a gate vestige or remnant is often left on the de-molded part (the part is molded in a mold cavity), caused by plastic being pulled from the gap between the valve stem and the mold gate. The gate vestige is commonly referred to as crown flash. To reduce the evidence of crown flash, the gap is preferably made as small as possible in the order of microns. The precision required to manufacture and inspect such fine measurements of both the gate orifice and stem plunger is costly. In addition, even though the two cylindrical features may be made to generate a very small clearance, alignment of the stem is such that keeping the plunger (valve stem) perfectly concentric to the gate orifice to the avoid contact and wear between the two cylindrical features is additionally difficult and dictates that the gap should be unfortunately larger than ideally desired. In addition, as the alignment features between the valve stem and valve-stem guidance features wear down, the valve stem and the gate orifice inevitably make contact and thereby enlargement of the gap size occurs over the passage of time, thereby inadvertently creating and/or increasing the evidence of crown flash.

The second type of valve gate shut-off involves a stem front geometry that impacts the gate orifice with a positive force. Ideally, the force is sufficient to squeeze out the plastic from the interface features between the valve stem and gate orifice. A common example of the interfacing feature is a simple taper. The taper may be an angle, between a few degrees or up to 60 degrees, for example. The problem with using a taper or other geometry that applies a force to the gate orifice is that the force applied by the stem-closing mechanism is variable and is imprecisely controlled. Variability is driven by many factors including (and not limited to): (a) tolerances of the components fabricated and how they stack up together in the assembly, (b) variability in bulk temperature and temperature gradient within the assembly, (c) lack of control or lack of consistency of the stem-moving mechanism, and/or (d) change in force over time as the interface features wear away. Variability may cause two significant problems, such as: (A) for the case where the force is too low, there may be a positive gap between the interfacing features, leading to evidence of crown flash, and/or (B) for the case where the force is too great, the interface may be overloaded causing undesirable wear and damage on the cavity gate orifice. The damage may lead to an unacceptable cracking or peening of the gate orifice. For large mold assemblies, this may undesirably increase to maintenance costs and increase downtime of production tool.

As a result, many molders prefer the plunger gate shut-off type (due to perceived lower operating disruption and costs), while they are still generally dissatisfied with the longevity of the plunger assembly and onset evidence of the inevitable crown flash due to the size of the gate orifice gap. The following are problems associated with taper-type interface between the gate orifice and the valve stem: (A) either no gap exists when the valve stem is placed in the closed position, or (B) a film of plastic exists in the taper interface but there is a clamping force on the film to prevent the film from being pulled out when the molded part is ejected form the mold assembly. Known systems exert too much force that inflict damage to the fine metal edge of the gate orifice.

In order to mitigate, at least in part, the above shortcomings, according to one aspect, there is provided a mold-tool system (100), comprising: a valve-stem assembly (102) being configured to move in a nozzle assembly (104), the valve-stem assembly (102) being configured to interact with a mold-gate orifice (105) defined by a mold-gate assembly (106), and a stem-actuator assembly (108) being configured to exert controlled movement of the valve-stem assembly (102) based on an amount of force (109) interacting between the valve-stem assembly (102) and the mold-gate assembly (106).

Other aspects and features of the non-limiting embodiments may now become apparent to those skilled in the art upon review of the following detailed description of the non-limiting embodiments with the accompanying drawings.

### DETAILED DESCRIPTION OF THE DRAWINGS

The non-limiting embodiments may be more fully appreciated by reference to the following detailed description of the non-limiting embodiments when taken in conjunction with the accompanying drawings, in which:

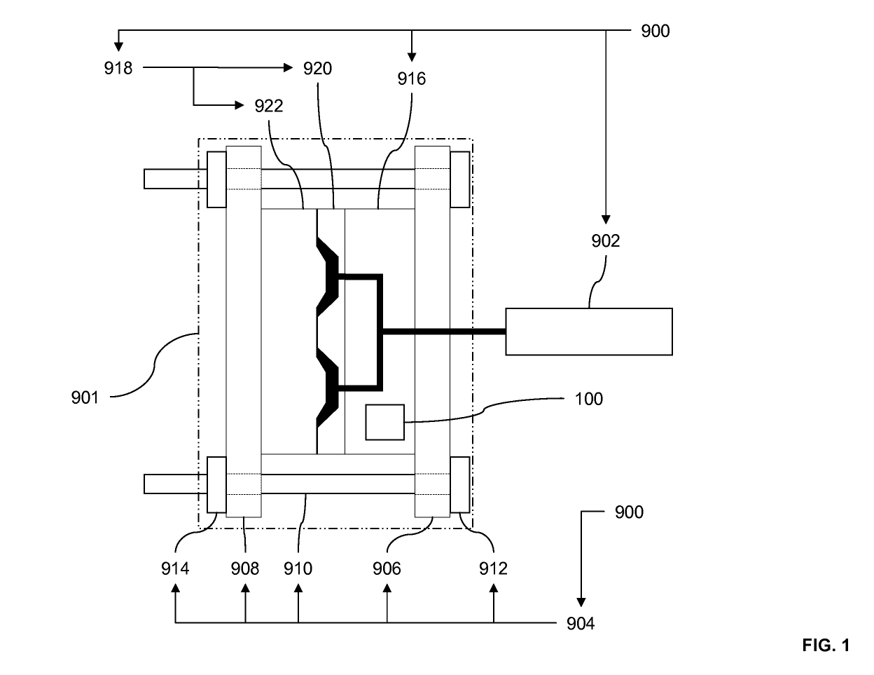

FIGS. 1-7 depict examples of schematic representations of a mold-tool system (100).

The drawings are not necessarily to scale and may be illustrated by phantom lines, diagrammatic representations and fragmentary views. In certain instances, details not necessary for an understanding of the embodiments (and/or details that render other details difficult to perceive) may have been omitted.

### DETAILED DESCRIPTION OF THE NON-LIMITING EMBODIMENT(S)

FIG. 1 depicts examples of the mold-tool system (100) having the molding system (900), and the mold-tool system (100) having the runner system (916). The molding system (900) and the runner system (916) may include components that are known to persons skilled in the art, and these known components may not be described here; these known components are described, at least in part, in the following reference books (for example): (i) “Injection Molding Handbook” authored by OSSWALD/TURNG/GRAMANN (ISBN: 3-446-21669-2), (ii) “Injection Molding Handbook” authored by ROSATO AND ROSATO (ISBN: 0-412-99381-3), (iii) “Injection Molding Systems” 3^{rd} Edition authored by JOHANNABER (ISBN 3-446-17733-7) and/or (iv) “Runner and Gating Design Handbook” authored by BEAUMONT (ISBN 1-446-22672-9). It may be appreciated that for the purposes of this document, the phrase “includes (but is not limited to)” is equivalent to the word “comprising.” The word “comprising” is a transitional phrase or word that links the preamble of a patent claim to the specific elements set forth in the claim that define what the invention itself actually is. The transitional phrase acts as a limitation on the claim, indicating whether a similar device, method, or composition infringes the patent if the accused device (etc) contains more or fewer elements than the claim in the patent. The word “comprising” is to be treated as an open transition, which is the broadest form of transition, as it does not limit the preamble to whatever elements are identified in the claim.

On the one hand, the mold-tool system (100), the molding system (900), and the runner system (916) may all be sold separately. That is, the mold-tool system (100) may be sold as a retrofit item (assembly) that may be installed to an existing molding system (not depicted) and/or an existing runner system (not depicted). In accordance with an option, it may be appreciated that the mold-tool system (100) may further include (and is not limited to): a runner system (916) configured to support the mold-tool system (100). In accordance with a first option, it may be appreciated that the mold-tool system (100) may further include (and is not limited to): a molding system (900) having a runner system (916) configured to support the mold-tool system (100). In accordance with second option, it may be appreciated that the mold-tool system (100) may further include (and is not limited to): a molding system (900) configured to support the mold-tool system (100). On the other hand, the mold-tool system (100), the molding system (900), and the runner system (916) may all be sold, to an end user, as an integrated product by one supplier.

More specifically, FIG. 1 depicts an example of a schematic representation of the molding system (900), and an example of a schematic representation of a mold-tool system (100). The molding system (900) may also be called an injection-molding system for example. According to the example depicted in FIG. 1, the molding system (900) includes (and is not limited to): (i) an extruder assembly (902), (ii) a clamp assembly (904), (iii) a runner system (916), and/or (iv) a mold assembly (918). By way of example, the extruder assembly (902) is configured, to prepare, in use, a heated, flowable resin, and is also configured to inject or to move the resin from the extruder assembly (902) toward the runner system (916). Other names for the extruder assembly (902) may include injection unit, melt-preparation assembly, etc. By way of example, the clamp assembly (904) includes (and is not limited to): (i) a stationary platen assembly (906), (ii) a movable platen assembly (908), (iii) a rod assembly (910), (iv) a clamping assembly (912), and/or (v) a lock assembly (914). The stationary platen assembly (906) does not move; that is, the stationary platen assembly (906) may be fixedly positioned relative to the ground or floor. The movable platen assembly (908) is configured to be movable relative to the stationary platen assembly (906). A platen-moving mechanism (not depicted but known) is connected to the movable platen assembly (908), and the platen-moving mechanism is configured to move, in use, the movable platen assembly (908). The rod assembly (910) extends between the movable platen assembly (908) and the stationary platen assembly (906). The rod assembly (910) may have, by way of example, four rod structures positioned at the corners of the respective stationary platen assembly (906) and the movable platen assembly (908). The rod assembly (910) is configured to guide movement of the movable platen assembly (908) relative to the stationary platen assembly (906). A clamping assembly (912) is connected to the rod assembly (910). The stationary platen assembly (906) is configured to support (or configured to position) the position of the clamping assembly (912). The lock assembly (914) is connected to the rod assembly (910), or may alternatively be connected to the movable platen assembly (908). The lock assembly (914) is configured to selectively lock and unlock the rod assembly (910) relative to the movable platen assembly (908). By way of example, the runner system (916) is attached to, or is supported by, the stationary platen assembly (906). The runner system (916) includes (and is not limited to) a mold-tool system (100). The definition of the mold-tool system (100) is as follows: a system that may be positioned and/or may be used in a platen envelope (901) defined by, in part, an outer perimeter of the stationary platen assembly (906) and the movable platen assembly (908) of the molding system (900) as depicted in FIG. 1. The molding system (900) may include (and is not limited to) the mold-tool system (100). The runner system (916) is configured to receive the resin from the extruder assembly (902). By way of example, the mold assembly (918) includes (and is not limited to): (i) a mold-cavity assembly (920), and (ii) a mold-core assembly (922) that is movable relative to the mold-cavity assembly (920). The mold-core assembly (922) is attached to or supported by the movable platen assembly (908). The mold-cavity assembly (920) is attached to or supported by the runner system (916), so that the mold-core assembly (922) faces the mold-cavity assembly (920). The runner system (916) is configured to distribute the resin from the extruder assembly (902) to the mold assembly (918).

In operation, the movable platen assembly (908) is moved toward the stationary platen assembly (906) so that the mold-cavity assembly (920) is closed against the mold-core assembly (922), so that the mold assembly (918) may define a mold cavity configured to receive the resin from the runner system (916). The lock assembly (914) is engaged so as to lock the position of the movable platen assembly (908) so that the movable platen assembly (908) no longer moves relative to the stationary platen assembly (906). The clamping assembly (912) is then engaged to apply a camping pressure, in use, to the rod assembly (910), so that the clamping pressure then may be transferred to the mold assembly (918). The extruder assembly (902) pushes or injects, in use, the resin to the runner system (916), which then the runner system (916) distributes the resin to the mold cavity structure defined by the mold assembly (918). Once the resin in the mold assembly (918) is solidified, the clamping assembly (912) is deactivated so as to remove the clamping force from the mold assembly (918), and then the lock assembly (914) is deactivated to permit movement of the movable platen assembly (908) away from the stationary platen assembly (906), and then a molded article may be removed from the mold assembly (918).

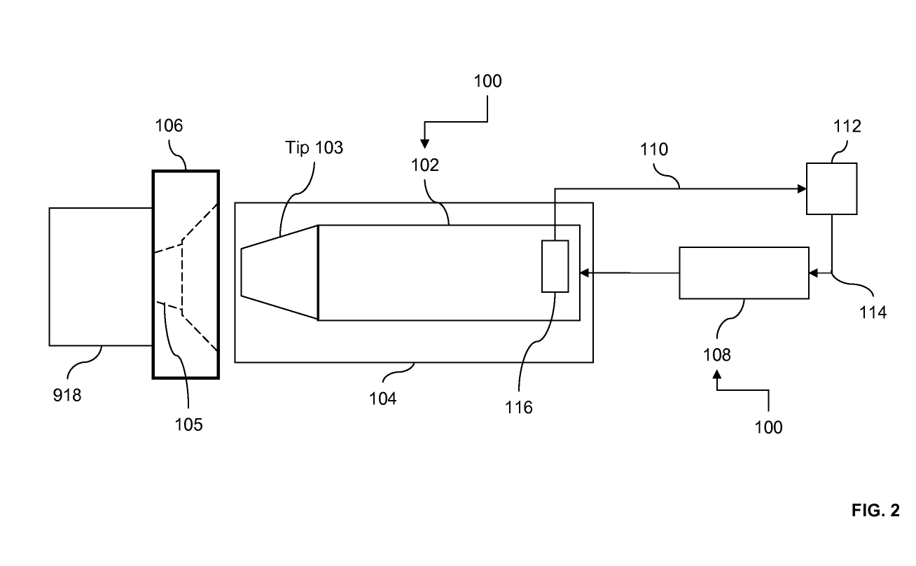

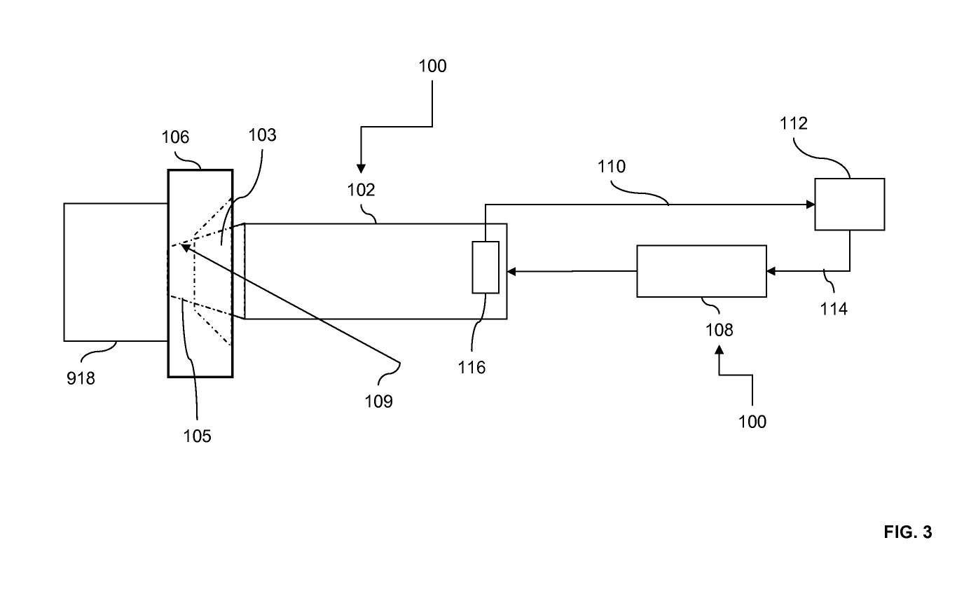

With reference to all of the FIGS., but more specifically to FIGS. 2 and 3, the mold-tool system (100) includes (and is not limited to): (i) a valve-stem assembly (102), and (ii) a stem-actuator assembly (108). The valve-stem assembly (102) is configured to move in a nozzle assembly (104). The valve-stem assembly (102) is configured to interact with a mold-gate orifice (105) defined by a mold-gate assembly (106). The stem-actuator assembly (108) is configured to exert controlled movement of the valve-stem assembly (102) based on an amount of a force (109) interacting between the valve-stem assembly (102) and the mold-gate assembly (106). The force (109) is depicted in FIG. 3. FIGS. 2 and 3 depict a type of combination of the valve-stem assembly (102) and the mold-gate assembly (106), which is generally known as a taper shut-off assembly. It may be appreciated that the mold-tool system (100) may be used with any type of shut-off assembly or any type or combination of the valve-stem assembly (102) and the mold-gate assembly (106).

The following describes further options or variations of the mold-tool system (100). The valve-stem assembly (102) is configured to interact with the mold-gate orifice (105) in the following way: the valve-stem assembly (102) is configured to: (i) open the mold-gate orifice (105), so as to permit flow of a flowable resin from the runner system (916) to the mold assembly (918) via the mold-gate assembly (106), and (ii) close the mold-gate orifice (105), so as to stop the flow of the flowable resin from the runner system (916) to the mold assembly (918) via the mold-gate assembly (106). When the mold-gate orifice (105) is open, valve-stem assembly (102) is in the open position. When the mold-gate orifice (105) is closed, the valve-stem assembly (102) is in the closed position. The stem-actuator assembly (108) is configured to connect to the valve-stem assembly (102), and to exert controlled movement of the valve-stem assembly (102). The stem-actuator assembly (108) is configured to exert controlled movement of the valve-stem assembly (102) such that the amount of force (109) interacting between the valve-stem assembly (102) and the mold-gate assembly (106) is kept within an acceptable limit.

The stem-actuator assembly (108) is configured to exert controlled movement such that the amount of force (109) that is kept within an acceptable limit is between an upper threshold limit and a lower threshold limit. The amount of force (109) may be independent from one mold cavity to the next mold cavity associated with the mold assembly (918). Each mold cavity of the mold assembly (918) is closed and opened independently by a respective valve-stem assembly (102). FIG. 1 depicts two mold cavities. It may be appreciated that the mold assembly (918) may have or define (by way of example) a quantity of 25, 50, 100, 150, 200 or more mold cavities. According to one example, the stem-actuator assembly (108) is configured to have a force sensor. According to another example, the stem-actuator assembly (108) is configured to having an electric actuator.

The stem-actuator assembly (108) is configured to exert controlled movement of the valve-stem assembly (102) based on a feedback signal (110) configured to provide an indication of an amount of force (109) exchanged between the valve-stem assembly (102) and the mold-gate assembly (106). The feedback signal (110) may be provided by a sensor assembly (116). The sensor assembly (116) may be used to detect the amount of force (109). Position or location of the sensor assembly (116) is not important, provided that the sensor assembly (116) is suitably positioned so as to sense the force (109), and provides an indication of the amount of the force (109). The sensor assembly (116) is depicted as being positioned in the valve-stem assembly (102), but it is appreciated that this is done as a convenience.

The feedback signal (110) identifies any one of the following cases: (i) the force exerted by the valve-stem assembly (102) to the mold-gate orifice (105) at the point of the valve-stem assembly (102) being closed, (ii) deceleration rate of the valve-stem assembly (102) within (for example) the last 0.5 mm (millimeter) of the valve-stem assembly (102) being stopped, and (iii) the final position of the valve-stem assembly (102) or the final position of the stem-actuator assembly (108) at the point of the valve-stem assembly (102) stops forward movement toward the mold-gate assembly (106). Use of the feedback signal (110) prescribes a resultant output of stem movement control, thereby applying a consistency in the force applied by the stem-actuator assembly (108) to the mold-gate orifice (105).

The following are examples in which the stem-actuator assembly (108) is configured to exert controlled movement according to any one of: (example A) the stem-actuator assembly (108) is configured to control position of the valve-stem assembly (102), based on the amount of force interacting between the valve-stem assembly (102) and the mold-gate assembly (106), and (example B) the stem-actuator assembly (108) is configured to control an amount of force to be applied to the valve-stem assembly (102), based on the amount of force interacting between the valve-stem assembly (102) and the mold-gate assembly (106). The stem-actuator assembly (108) is configured to control: (i) position of the valve-stem assembly (102), and (ii) an amount of force to be applied to the valve-stem assembly (102), based on the amount of force interacting between the valve-stem assembly (102) and the mold-gate assembly (106).

A technical effect of the mold-tool system (100) is that an acceptable amount of force may be consistently transferred from the valve-stem assembly (102) to the mold-gate assembly (106) so that a quality of the gate vestige may be optimized, and/or longevity of the quality of the gate-vestige may be enhanced. The gate vestige is an undesirable portion of the molded article that is formed, and it is usually associated with the geometry associated with the manner in which the valve-stem assembly (102) and the mold-gate assembly (106) interact together.

A controller assembly (112) is configured to receive the feedback signal (110). The controller assembly (112) is configured to provide a control signal (114) to the stem-actuator assembly (108). For the case where the mold assembly (918) defines or provides a plurality of mold cavities, the controller assembly (112) is configured to control individual instances of the stem-actuator assembly (108) that are used to control their respective valve-stem assembly (102). For the case where the mold assembly (918) defines or provides a plurality of mold cavities, the mold-tool system (100) is configured to each valve-stem assembly (102) having individual movement control in combination with a respective (dedicated) feedback signal. According to an option, the controller assembly (112) is configured to exert closed-loop control of the stem-actuator assembly (108). According to another option, the controller assembly (112) is configured to exert open-loop control of the stem-actuator assembly (108). However, it may be appreciated that for the case where the stem-actuator assembly (108) includes a single plate system that is attached to a plurality of valve-stem assembly (102), and the mold assembly (918) defines or provides a plurality of mold cavities, the controller assembly (112) is configured to control the stem-actuator assembly (108) that is used to control all of the valve-stem assembly (102) in unison.

It may be appreciated that the mold-tool system (100) may be used with any type of shut-off assembly or any type or combination of the valve-stem assembly (102) and the mold-gate assembly (106). According to what is depicted in FIG. 2, the interface between the valve-stem assembly (102) and the mold-gate assembly (106) is a tapered interface on a forward geometry of the valve-stem assembly (102) such that the tapered interface applies a pressure to a corresponding shape on the mold-gate assembly (106) for the case where the valve-stem assembly (102) is moved to the closed position. The valve-stem assembly (102) is driven by the stem-actuator assembly (108) configured to be adjusted either while simultaneously making production parts—that is, molded articles formed in the mold cavity of the mold assembly (918), or during stoppage of a machine cycle of the molding system (900). The adjustment of the stem-actuator assembly (108) may be prescribed by any one of: (i) a function of either stem force at the end of the closed position of the valve-stem assembly (102), or (ii) the deceleration of the valve-stem assembly (102) immediately preceding the closed position of the valve-stem assembly (102), or (iii) the position of the valve-stem assembly (102) at the closed position of the valve-stem assembly (102). The adjustment may take place using the controller assembly (112) configured to control: (a) movement of the valve-stem assembly (102), or (b) stop point based on information provided to the controller assembly (112) related to stem force, deceleration of the valve-stem assembly (102) or the stop position of the valve-stem assembly (102). Controlled movement of the valve-stem assembly (102) may be a user-defined input value to the controller assembly (112), that may be inputted by keyboard or a value stored in the memory of the controller assembly (112).

By way of example, the stem-actuator assembly (108) includes (and is not limited to) a brushless DC motor, or a servo motor, connected to the valve-stem assembly (102) to drive reciprocating motion of the valve-stem assembly (102). In operation, the stem-actuator assembly (108) is controlled by degree of rotation and any one of the power and torque required to make the stem-actuator assembly (108) reach the desired number of degrees of rotation. As the valve-stem assembly (102) reaches an end position to close the mold-gate orifice (105), the power required for the stem-actuator assembly (108) to reach its rotational position may increase. This is due to the valve-stem assembly (102) having to displace the flowable resin in the interface located between the valve-stem assembly (102) and the mold-gate assembly (106) in the mold-gate orifice (105), which may otherwise come together with relatively little added force. For the case where the power (or torque) of the stem-actuator assembly (108) increases and the stem-actuator assembly (108) rotates by some additional degrees, the valve-stem assembly (102) pushes harder to advance against the corresponding interface at the mold-gate assembly (106). Because the stem-actuator assembly (108) may keep its power level in check and limit the amount of power that is applied to reach rotation travel of the stem-actuator assembly (108), a power level may be assigned for the stem-actuator assembly (108) to repeat at every closing of the mold-gate orifice (105) so as to result in a consistent amount of force at the interface between the valve-stem assembly (102) and the mold-gate assembly (106). Once a setting is determined that may produce a consistently acceptable gate vestige (or ideally no gate vestige) while concurrently not applying excessive force to achieve the desired gate vestige, the stem-actuator assembly (108) may operate in a self regulating mode, regardless of: (a) changes in component tolerances and dimensions, (b) changes or variation in bulk assembly temperature, (c) changes in temperature gradients, (d) changes in plastic viscosity, etc. For the case where the constituent parts have a tendency to wear as a result of erosion due to plastic flow of the flowable resin, the stem-actuator assembly (108) may accommodate the wear by advancing the closed position of the valve-stem assembly (102) in order to achieve the power and/or torque setting originally prescribed, and thus achieve the requisite gate quality.

Referring now to FIG. 3, there is depicted the condition in which the feedback signal (110) indicates: a case where the valve-stem assembly (102) is positioned so as to close the mold-gate orifice (105). The feedback signal (110) indicates an amount of force exerted by the valve-stem assembly (102) to the mold-gate orifice (105) in which the amount of force exerted does not exceed a limit.

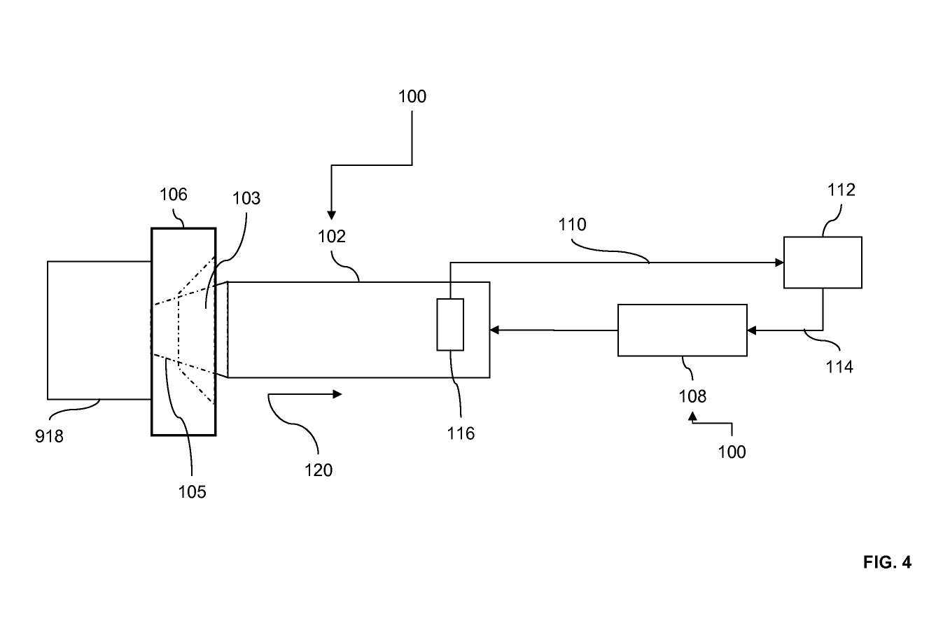

Referring now to FIG. 4, there is depicted a deceleration rate (120) of the valve-stem assembly (102). The feedback signal indicates: a case where the valve-stem assembly (102) is moved to the closed position and the deceleration rate (120) is monitored during the last 0.5 mm of travel of the valve-stem assembly (102) and thereafter is duplicated and controlled by the stem-actuator assembly (108) for subsequent molding cycles of the molding system (900).

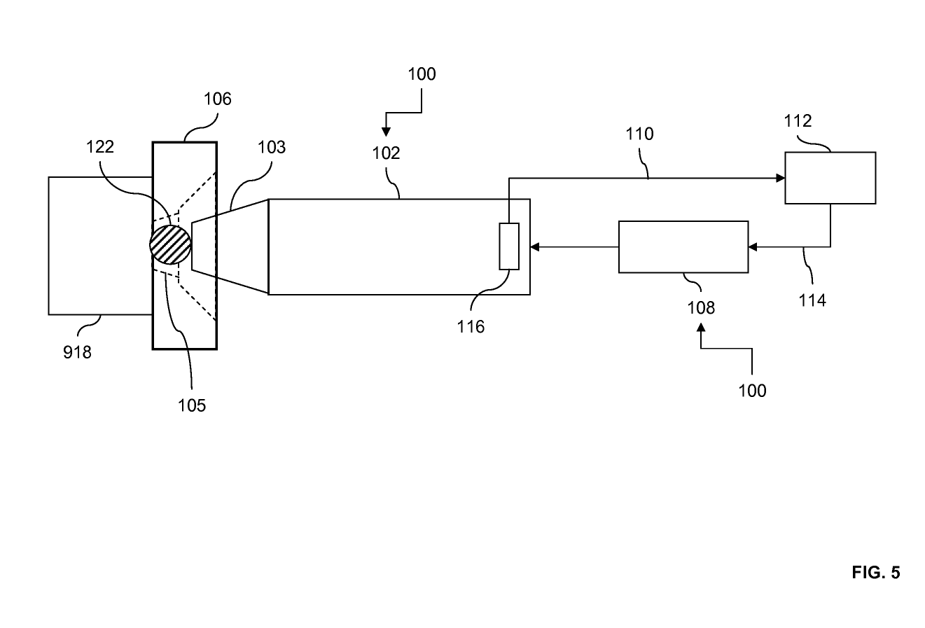

Referring now to FIG. 5, there is depicted a solidified resin (122). The feedback signal (110) indicates: a case where the valve-stem assembly (102) stops moving forward based on a measured parameter. The measured parameter may be a force measurement or may be a current measurement—that is, the current consumed by the stem-actuator assembly (108). For a subsequent molding cycle of the molding system (900), the stem-actuator assembly (108) moves the valve-stem assembly (102) to the same stop position irrespective of the amount of the measured parameter (either the force measurement or the current measurement) required to move the valve-stem assembly (102) to the established closed position. The controller assembly (112) or the stem-actuator assembly (108) may substitute as the sensor between the stem-actuator assembly (108) and the valve-stem assembly (102). The controller assembly (112) may cause rotation of the stem-actuator assembly (108) to a position and measure its own current to achieve the position. The controller assembly (112) may then switch to achieving the position but allowing variability in current to get there. The benefit is that if the flowable resin becomes more viscous (with time, or variation in resin quality or temperature), the valve-stem assembly (102) may not stop short of the closed position but also not try to advance the valve-stem assembly (102) past the previously defined position/rotation.

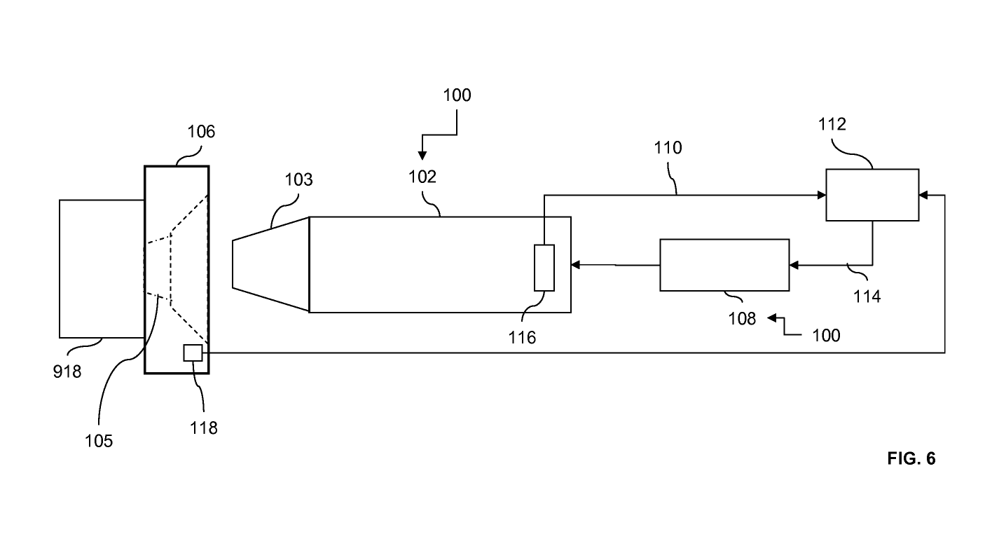

Referring now to FIG. 6, there is depicted a temperature sensor assembly (118). For the case where further adjustment of position of the valve-stem assembly (102) is made automatically based on thermal growth or contraction of the valve-stem assembly (102) as identified by feedback from the temperature sensor assembly (118) to the controller assembly (112). According to one option, the temperature sensor assembly (118) is configured to measure temperature of the mold-gate assembly (106).

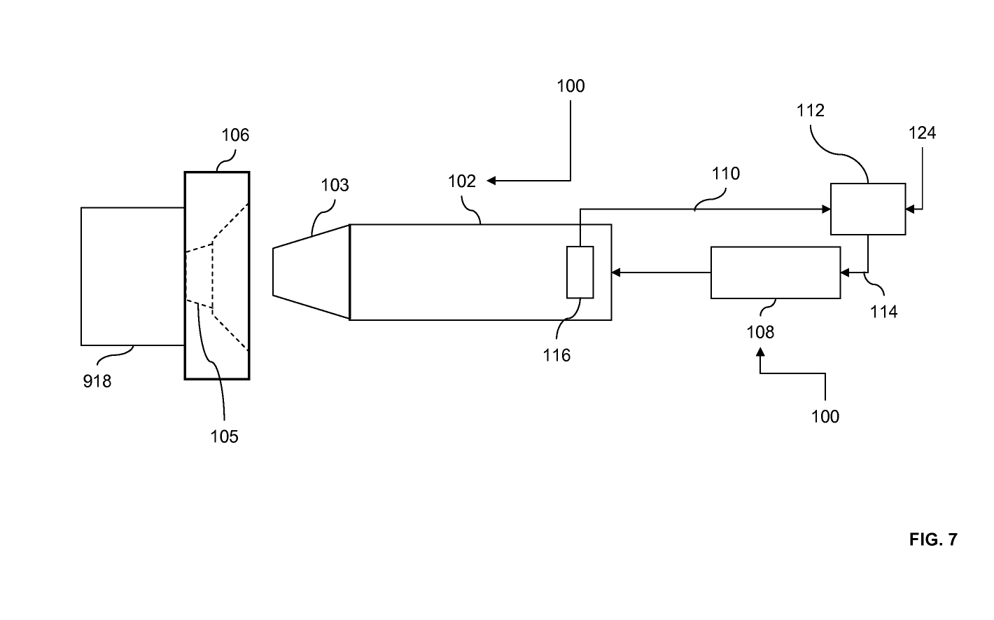

Referring now to FIG. 7, there is depicted a case where additional input for control is provided such that a positional offset is prescribed by selecting a resin type (124) to be used (inputted) by the controller assembly (112).

### Controller Assembly (112)

According to one option, the controller assembly (112) includes controller-executable instructions configured to operate the stem-actuator assembly (108) in accordance with the description provided above. The controller assembly (112) may use computer software, or just software, which is a collection of computer programs (controller-executable instructions) and related data that provide the instructions for instructing the controller assembly (112) what to do and how to do it. In other words, software is a conceptual entity that is a set of computer programs, procedures, and associated documentation concerned with the operation of a controller assembly, also called a data-processing system. Software refers to one or more computer programs and data held in a storage assembly (a memory module) of the controller assembly for some purposes. In other words, software is a set of programs, procedures, algorithms and its documentation. Program software performs the function of the program it implements, either by directly providing instructions to computer hardware or by serving as input to another piece of software. In computing, an executable file (executable instructions) causes the controller assembly (112) to perform indicated tasks according to encoded instructions, as opposed to a data file that must be parsed by a program to be meaningful. These instructions are machine-code instructions for a physical central processing unit. However, in a more general sense, a file containing instructions (such as bytecode) for a software interpreter may also be considered executable; even a scripting language source file may therefore be considered executable in this sense. While an executable file can be hand-coded in machine language, it is far more usual to develop software as source code in a high-level language understood by humans, or in some cases, an assembly language more complex for humans but more closely associated with machine code instructions. The high-level language is compiled into either an executable machine code file or a non-executable machine-code object file; the equivalent process on assembly language source code is called assembly. Several object files are linked to create the executable. The same source code can be compiled to run under different operating systems, usually with minor operating-system-dependent features inserted in the source code to modify compilation according to the target. Conversion of existing source code for a different platform is called porting. Assembly-language source code and executable programs are not transportable in this way. An executable comprises machine code for a particular processor or family of processors. Machine-code instructions for different processors are completely different and executables are totally incompatible. Some dependence on the particular hardware, such as a particular graphics card may be coded into the executable. It is usual as far as possible to remove such dependencies from executable programs designed to run on a variety of different hardware, instead installing hardware-dependent device drivers on the controller assembly (112), which the program interacts with in a standardized way. Some operating systems designate executable files by filename extension (such as .exe) or noted alongside the file in its metadata (such as by marking an execute permission in Unix-like operating systems). Most also check that the file has a valid executable file format to safeguard against random bit sequences inadvertently being run as instructions. Modern operating systems retain control over the resources of the controller assembly (112), requiring that individual programs make system calls to access privileged resources. Since each operating system family features its own system call architecture, executable files are generally tied to specific operating systems, or families of operating systems. There are many tools available that make executable files made for one operating system work on another one by implementing a similar or compatible application binary interface. When the binary interface of the hardware the executable was compiled for differs from the binary interface on which the executable is run, the program that does this translation is called an emulator. Different files that can execute but do not necessarily conform to a specific hardware binary interface, or instruction set, can be represented either in bytecode for Just-in-time compilation, or in source code for use in a scripting language.

According to another option, the controller assembly (112) includes application-specific integrated circuits configured to operate the stem-actuator assembly (108) in accordance with the description provided above. It may be appreciated that an alternative to using software (controller-executable instructions) in the controller assembly (112) is to use an application-specific integrated circuit (ASIC), which is an integrated circuit (IC) customized for a particular use, rather than intended for general-purpose use. For example, a chip designed solely to run a cell phone is an ASIC. Some ASICs include entire 32-bit processors, memory blocks including ROM, RAM, EEPROM, Flash and other large building blocks. Such an ASIC is often termed a SoC (system-on-chip). Designers of digital ASICs use a hardware description language (HDL) to describe the functionality of ASICs. Field-programmable gate arrays (FPGA) are used for building a breadboard or prototype from standard parts; programmable logic blocks and programmable interconnects allow the same FPGA to be used in many different applications. For smaller designs and/or lower production volumes, FPGAs may be more cost effective than an ASIC design. A field-programmable gate array (FPGA) is an integrated circuit designed to be configured by the customer or designer after manufacturing-hence field-programmable. The FPGA configuration is generally specified using a hardware description language (HDL), similar to that used for an application-specific integrated circuit (ASIC) (circuit diagrams were previously used to specify the configuration, as they were for ASICs, but this is increasingly rare). FPGAs can be used to implement any logical function that an ASIC could perform. The ability to update the functionality after shipping, partial re-configuration of the portion of the design and the low non-recurring engineering costs relative to an ASIC design offer advantages for many applications. FPGAs contain programmable logic components called logic blocks, and a hierarchy of reconfigurable interconnects that allow the blocks to be wired together-somewhat like many (changeable) logic gates that can be inter-wired in (many) different configurations. Logic blocks can be configured to perform complex combinational functions, or merely simple logic gates like AND and XOR. In most FPGAs, the logic blocks also include memory elements, which may be simple flip-flops or more complete blocks of memory. In addition to digital functions, some FPGAs have analog features. The most common analog feature is programmable slew rate and drive strength on each output pin, allowing the engineer to set slow rates on lightly loaded pins that would otherwise ring unacceptably, and to set stronger, faster rates on heavily loaded pins on high-speed channels that would otherwise run too slow. Another relatively common analog feature is differential comparators on input pins designed to be connected to differential signaling channels. A few “mixed signal FPGAs” have integrated peripheral Analog-to-Digital Converters (ADCs) and Digital-to-Analog Converters (DACs) with analog signal conditioning blocks allowing them to operate as a system-on-a-chip. Such devices blur the line between an FPGA, which carries digital ones and zeros on its internal programmable interconnect fabric, and field-programmable analog array (FPAA), which carries analog values on its internal programmable interconnect fabric.

### Additional Description

The following clauses are offered as further description of the examples of the mold-tool system (100): Clause (1): a mold-tool system (100), comprising: a valve-stem assembly (102) being configured to move in a nozzle assembly (104), the valve-stem assembly (102) being configured to interact with a mold-gate orifice (105) defined by a mold-gate assembly (106); and a stem-actuator assembly (108) being configured to exert controlled movement of the valve-stem assembly (102) based on an amount of force (109) interacting between the valve-stem assembly (102) and the mold-gate assembly (106). Clause (2): the mold-tool system (100) of any clause mentioned in this paragraph, wherein: the feedback signal (110) indicates a case where the valve-stem assembly (102) is positioned so as to close the mold-gate orifice (105). The feedback signal (110) indicates an amount of force exerted by the valve-stem assembly (102) to the mold-gate orifice (105) in which the amount of force exerted does not exceed a limit. Clause (3): the mold-tool system (100) of any clause mentioned in this paragraph, wherein: the feedback signal indicates a case where the valve-stem assembly (102) is moved to the closed position and the deceleration rate (120) is monitored during the last 0.5 mm of travel of the valve-stem assembly (102) and thereafter is duplicated and controlled by the stem-actuator assembly (108) for subsequent molding cycles of the molding system (900). Clause (4): the mold-tool system (100) of any clause mentioned in this paragraph, wherein: the feedback signal (110) indicates a case where the valve-stem assembly (102) stops moving forward based on a measured parameter, and for a subsequent molding cycle of the molding system (900), the stem-actuator assembly (108) moves the valve-stem assembly (102) to the same stop position irrespective of the amount of the measured parameter required to move the valve-stem assembly (102) to the established closed position. Clause (5): the mold-tool system (100) of any clause mentioned in this paragraph, wherein: for the case where further adjustment of position of the valve-stem assembly (102) is made automatically based on thermal growth or contraction of the valve-stem assembly (102) as identified by feedback from a temperature sensor assembly (118) to the controller assembly (112). Clause (6): the mold-tool system (100) of any clause mentioned in this paragraph, wherein: for the case where additional input for control is provided such that a positional offset is prescribed by selecting a resin type (124) to be used (inputted) by the controller assembly (112). Clause (7): the mold-tool system (100) of any clause mentioned in this paragraph, wherein: the valve-stem assembly (102) is configured to: (i) open the mold-gate orifice (105), so as to permit flow of a flowable resin from the runner system (916) to the mold assembly (918) via the mold-gate assembly (106), and (ii) close the mold-gate orifice (105), so as to stop the flow of the flowable resin from the runner system (916) to the mold assembly (918) via the mold-gate assembly (106). Clause (8): the mold-tool system (100) of any clause mentioned in this paragraph, wherein: the stem-actuator assembly (108) is configured to exert controlled movement of the valve-stem assembly (102) such that the amount of force (109) interacting between the valve-stem assembly (102) and the mold-gate assembly (106) is kept within an acceptable limit. Clause (9): the mold-tool system (100) of any clause mentioned in this paragraph, wherein: the stem-actuator assembly (108) is configured to exert controlled movement such that the amount of force (109) that is kept within an acceptable limit is between an upper threshold limit and a lower threshold limit. Clause (10): the mold-tool system (100) of any clause mentioned in this paragraph, wherein: the amount of force (109) may be independent from one mold cavity to the next mold cavity associated with the mold assembly (918), each mold cavity of the mold assembly (918) is closed and opened independently by a respective valve-stem assembly (102). Clause (11): the mold-tool system (100) of any clause mentioned in this paragraph, wherein: the stem-actuator assembly (108) is configured to exert controlled movement of the valve-stem assembly (102) based on a feedback signal (110) configured to provide an indication of an amount of force (109) exchanged between the valve-stem assembly (102) and the mold-gate assembly (106). Clause (12): the mold-tool system (100) of any clause mentioned in this paragraph, wherein: the stem-actuator assembly (108) is configured to exert controlled movement of the valve-stem assembly (102) based on a feedback signal (110) configured to provide an indication of an amount of force (109) exchanged between the valve-stem assembly (102) and the mold-gate assembly (106), and the feedback signal (110) identifies any one of: (i) the force exerted by the valve-stem assembly (102) to the mold-gate orifice (105) at the point of the valve-stem assembly (102) being closed, (ii) deceleration rate of the valve-stem assembly (102) within (for example) the last 0.5 mm (millimeter) of the valve-stem assembly (102) being stopped, and (iii) the final position of the valve-stem assembly (102) or the final position of the stem-actuator assembly (108) at the point of the valve-stem assembly (102) stops forward movement toward the mold-gate assembly (106). Clause (13): the mold-tool system (100) of any clause mentioned in this paragraph, wherein: the stem-actuator assembly (108) is configured to exert controlled movement according to any one of: (A) the stem-actuator assembly (108) is configured to control position of the valve-stem assembly (102), based on the amount of force interacting between the valve-stem assembly (102) and the mold-gate assembly (106), and (B) the stem-actuator assembly (108) is configured to control an amount of force to be applied to the valve-stem assembly (102), based on the amount of force interacting between the valve-stem assembly (102) and the mold-gate assembly (106). Clause (14): the mold-tool system (100) of any clause mentioned in this paragraph, wherein: the stem-actuator assembly (108) is configured to control: (i) position of the valve-stem assembly (102), and (ii) an amount of force to be applied to the valve-stem assembly (102), based on the amount of force interacting between the valve-stem assembly (102) and the mold-gate assembly (106). Clause (15): the mold-tool system (100) of any clause mentioned in this paragraph, wherein: a controller assembly (112) is configured to receive the feedback signal (110), and the controller assembly (112) is configured to provide a control signal (114) to the stem-actuator assembly (108). Clause (16): the mold-tool system (100) of any clause mentioned in this paragraph, wherein: a controller assembly (112) is configured to receive the feedback signal (110), and the controller assembly (112) is configured to provide a control signal (114) to the stem-actuator assembly (108), and for the case where the mold assembly (918) defines or provides a plurality of mold cavities, the controller assembly (112) is configured to control individual instances of the stem-actuator assembly (108) that are used to control their respective valve-stem assembly (102). Clause (17): the mold-tool system (100) of any clause mentioned in this paragraph, wherein: the interface between the valve-stem assembly (102) and the mold-gate assembly (106) is a tapered interface. Clause (18): the mold-tool system (100) of any clause mentioned in this paragraph, wherein: the adjustment of the stem-actuator assembly (108) is prescribed by any one of: (i) a function of either stem force at the end of the closed position of the valve-stem assembly (102), (ii) the deceleration of the valve-stem assembly (102) immediately preceding the closed position of the valve-stem assembly (102), and (iii) the position of the valve-stem assembly (102) at the closed position of the valve-stem assembly (102). Clause (19): the mold-tool system (100) of any clause mentioned in this paragraph, further comprising: a runner system (916) configured to support the mold-tool system (100). Clause (20): the mold-tool system (100) of any clause mentioned in this paragraph, further comprising: a molding system (900) having a runner system (916) configured to support the mold-tool system (100). Clause (21): the mold-tool system (100) of any clause mentioned in this paragraph, further comprising: a molding system (900) configured to support the mold-tool system (100).

It may be appreciated that the assemblies and modules described above may be connected with each other as may be required to perform desired functions and tasks that are within the scope of persons of skill in the art to make such combinations and permutations without having to describe each and every one of them in explicit terms. There is no particular assembly, components, or software code that is superior to any of the equivalents available to the art. There is no particular mode of practicing the inventions and/or examples of the invention that is superior to others, so long as the functions may be performed. It is believed that all the crucial aspects of the invention have been provided in this document. It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) description provided outside of this document (that is, outside of the instant application as filed, as prosecuted, and/or as granted). It is understood, for the purposes of this document, the phrase “includes (and is not limited to)” is equivalent to the word “comprising.” It is noted that the foregoing has outlined the non-limiting embodiments (examples). The description is made for particular non-limiting embodiments (examples). It is understood that the non-limiting embodiments are merely illustrative as examples.

1. A mold-tool system, comprising:
a valve-stem assembly being configured to move in a nozzle assembly, the valve-stem assembly being configured to interact with a mold-gate orifice defined by a mold-gate assembly; and
a stem-actuator assembly being configured to exert controlled movement of the valve-stem assembly based on an amount of force interacting between the valve-stem assembly and the mold-gate assembly such that the amount of force interacting between the valve-stem assembly and the mold-gate assembly does not exceed a limit.

2. The mold-tool system of claim 1, wherein:
a feedback signal indicates a case where the valve-stem assembly is positioned so as to close the mold-gate orifice by indicating the amount of force exerted by the valve-stem assembly to the mold-gate orifice.

3. The mold-tool system of claim 1, wherein:
a feedback signal indicates a case where the valve-stem assembly is moved to a closed position and a deceleration rate is monitored during the last 0.5 mm of travel of the valve-stem assembly and thereafter is duplicated and controlled by the stem-actuator assembly for subsequent molding cycles of a molding system.

4. The mold-tool system of claim 1, wherein:
a feedback signal indicates a case where the valve-stem assembly stops moving forward based on a measured parameter, and for a subsequent molding cycle of a molding system, the stem-actuator assembly moves the valve-stem assembly to the same stop position irrespective of an amount of the measured parameter required to move the valve-stem assembly to a closed position.

5. The mold-tool system of claim 1, wherein:
for a case where further adjustment of position of the valve-stem assembly is made automatically based on thermal growth or contraction of the valve-stem assembly as identified by feedback from a temperature sensor assembly to a controller assembly.

6. The mold-tool system of claim 1, wherein:
for a case where additional input for control is provided such that a positional offset is prescribed by selecting a resin type to be used (inputted) by a controller assembly.

7. The mold-tool system of claim 1, wherein:
the valve-stem assembly is configured to: (i) open the mold-gate orifice, so as to permit flow of a flowable resin from a runner system to a mold assembly via the mold-gate assembly, and
(ii) close the mold-gate orifice, so as to stop the flow of the flowable resin from the runner system to the mold assembly via the mold-gate assembly.

8. The mold-tool system of claim 1, wherein:
the stem-actuator assembly is configured to exert controlled movement of the valve-stem assembly such that the amount of force interacting between the valve-stem assembly and the mold-gate assembly is kept within an acceptable limit.

9. The mold-tool system of claim 8, wherein:
the stem-actuator assembly is configured to exert controlled movement such that the amount of force that is kept within an acceptable limit is between an upper threshold limit and a lower threshold limit.

10. The mold-tool system of claim 1, wherein:
the amount of force is independent from one mold cavity to a next mold cavity associated with a mold assembly, and each mold cavity of the mold assembly is closed and opened independently by a respective valve-stem assembly.

11. The mold-tool system of claim 1, wherein:
the stem-actuator assembly is configured to exert controlled movement of the valve-stem assembly based on a feedback signal configured to provide an indication of the amount of force exchanged between the valve-stem assembly and the mold-gate assembly.

12. The mold-tool system of claim 1, wherein:
the stem-actuator assembly is configured to exert controlled movement of the valve-stem assembly based on a feedback signal configured to provide an indication of the amount of force exchanged between the valve-stem assembly and the mold-gate assembly, and
the feedback signal identifies any one of:
(i) a force exerted by the valve-stem assembly to the mold-gate orifice (105) at a point of the valve-stem assembly being closed,
(ii) deceleration rate of the valve-stem assembly within the last 0.5 mm (millimeter) of the valve-stem assembly being stopped, and
(iii) a final position of the valve-stem assembly or the final position of the stem-actuator assembly at the point of the valve-stem assembly stops forward movement toward the mold-gate assembly.

13. The mold-tool system of claim 1, wherein:
the stem-actuator assembly is configured to exert controlled movement according to any one of:
(A) the stem-actuator assembly is configured to control position of the valve-stem assembly, based on the amount of force interacting between the valve-stem assembly (102) and the mold-gate assembly, and
(B) the stem-actuator assembly is configured to control the amount of force to be applied to the valve-stem assembly, based on the amount of force interacting between the valve-stem assembly and the mold-gate assembly.

14. The mold-tool system of claim 1, wherein:
the stem-actuator assembly is configured to control:
(i) position of the valve-stem assembly, and
(ii) the amount of force to be applied to the valve-stem assembly, based on the amount of force interacting between the valve-stem assembly and the mold-gate assembly.

15. The mold-tool system of claim 1, wherein:
a controller assembly is configured to receive a feedback signal, and the controller assembly is configured to provide a control signal (114) to the stem-actuator assembly.

16. The mold-tool system of claim 1, wherein:
a controller assembly is configured to receive a feedback signal, and the controller assembly is configured to provide a control signal to the stem-actuator assembly, and
for a case where a mold assembly defines or provides a plurality of mold cavities, the controller assembly is configured to control individual instances of the stem-actuator assembly that are used to control their respective valve-stem assembly.

17. The mold-tool system of claim 1, wherein:
an interface between the valve-stem assembly and the mold-gate assembly is a tapered interface.

18. The mold-tool system of claim 1, wherein:
adjustment of the stem-actuator assembly is prescribed by any one of:
(i) a function of either stem force at an end of a closed position of the valve-stem assembly,
(ii) deceleration of the valve-stem assembly immediately preceding the closed position of the valve-stem assembly, and
(iii) a position of the valve-stem assembly at the closed position of the valve-stem assembly.

19. The mold-tool system of claim 1, further comprising:
a runner system configured to support the mold-tool system.

20. The mold-tool system of claim 1, further comprising:
a molding system having a runner system configured to support the mold-tool system.

21. (cancelled)
